(19) United States
(12) Patent Application Publication
(10) Pub. No.: US 2025/0127603 A1
(43) Pub. Date: Apr. 24, 2025

(54) CUSTOMIZED MOUTHPIECE AND DRIVE MECHANISM COUPLED VIA MULTIPLE CONNECTION POINTS

(71) Applicant: ZeroBrush, Inc., San Diego, CA (US)

(72) Inventors: Nidhi PAI, Del Mar, CA (US); Akash PAI, Del Mar, CA (US); William ANDERSON, Seattle, WA (US); Josaiah CLARK, Kenmore, WA (US); Spencer MORSE, Seattle, WA (US)

(21) Appl. No.: 18/920,790

(22) Filed: Oct. 18, 2024

Related U.S. Application Data
(60) Provisional application No. 63/592,130, filed on Oct. 20, 2023.

(51) Int. Cl. A61C 17/22

(52) U.S. Cl. CPC A61C 17/228

(57) ABSTRACT

The dental care device comprises a drive mechanism and a customized mouthpiece. The drive mechanism comprises a first motor connection point, a second motor connection point, and one or more motors. The customized mouthpiece is configured to couple with the drive mechanism, and comprises: a first region including a first mouthpiece connection point configured to engage with the first motor connection point; a second region including a second mouthpiece connection point configured to engage with the second motor connection point; and a third region connection the first region and the second region, such that the first region can be moved independently of the second region.

### RELATED APPLICATIONS

This application claims priority to U.S. Provisional Application No. 63/592,130, filed Oct. 20, 2023, entitled “Customized Mouthpiece and Drive Mechanism Coupled Via Multiple Connection Points,” which is incorporated by reference in its entirety.

### TECHNICAL FIELD

This disclosure relates generally to dental care, including but not limited to, devices and systems for providing customized dental care.

### BACKGROUND

Toothbrushes are typically used for conventional teeth cleaning. Such toothbrushes generally have clustered bristles on a brush head that are brought into contact with a user's teeth and gums and moved about the user's mouth by the user for sequential cleaning of different areas of the user's teeth. The effectiveness of using a toothbrush to clean teeth is highly dependent on the technique and duration of the brushing, which many users find difficult to master or apply consistently. It is difficult for many users, particularly for children and the elderly, to brush all teeth surfaces using the optimal technique.

Moreover, conventional toothbrushes are designed to clean one side of one or more adjacent teeth at any given time. For example, the brush head of a manual or powered toothbrush has a width on the order of the width of a single adult tooth. Therefore, it often takes a person 2-5 minutes to clean all of his/her teeth adequately. For example, the American Dental Association recommends brushing one's teeth for 2-3 minutes (e.g., 30 seconds per quadrant) using a manual toothbrush.

Unfortunately, many people brush their teeth for significantly less than the recommended length of time. For example, without a timer, a user often overestimates the length of time that the user has been brushing his/her teeth. Even with a timer (e.g., a toothbrush with a quadrant timer), the user still may not brush each tooth surface within a quadrant with uniformity relative to the other tooth surfaces within the quadrant. Furthermore, people may underbrush or overbrush. For example, people may underbrush by not following the recommended brushing process or time spent per tooth, and people may overbrush by vigorously applying pressure or abrasive action to their gums, thereby abrading their enamel or gums.

Furthermore, it can be difficult for a user to clean certain regions of his/her teeth using a conventional toothbrush. For example, it can be difficult for a user to properly engage the brush head of a conventional manual or electric toothbrush with the backs of the molars on the same side as the hand in which the user is holding the toothbrush. A user with a sensitive mouth/throat may avoid brushing the backs of his/her molars to avoid triggering his/her gag reflex. Consequently, even people who brush their teeth regularly may not clean their teeth properly.

To address these issues, different full-mouth toothbrush designs have been explored. Such toothbrush designs, however, suffer from other limitations. For example, such toothbrush devices are generally coupled to a drive mechanism (e.g., with a motor) that transmits vibrational motion to a mouthpiece (e.g., with bristles and/or other cleaning elements). The vibrational motion is critical to moving the bristles and/or other cleaning elements to clean a user's teeth, but it is difficult to transmit adequate (e.g., and/or uniform) vibrational movement to all parts of a mouthpiece. Generally, the mouthpiece couples to the drive mechanism at the front of the mouthpiece (e.g., where the user's front teeth are), which makes it difficult to transmit sufficient vibrational movement to portions of the mouthpiece (e.g., regions of the mouthpiece corresponding to the user's molars and/or back teeth) that are far away from the connection point. Simply increasing the strength (e.g., amplitude) of vibrational motion transmitted by the drive mechanism is impractical, as this results in user discomfort in regions closer to the drive mechanism (e.g., the user's front teeth).

As such, a need has arisen for a dental device (e.g., a toothbrush) that is convenient to operate, that can effectively clean a user's teeth, and that can efficiently transmit energy to the necessary regions of the toothbrush device.

### SUMMARY

In light of these drawbacks, there is a need for a dental care system that accurately and precisely cleans and maintains a user's teeth and gums (i.e., dental health), without causing discomfort to the user, and without requiring complex or intricate dental cleaning regimes. Such systems optionally complement or replace conventional systems, devices, and methods for maintaining a user's dental health.

Accordingly, some embodiments described herein include a customized toothbrush device that includes a mouthpiece and a drive assembly. The mouthpiece is configured to couple with the drive assembly via at least two points of contact (e.g., connection points). In some embodiments, the drive assembly includes at least two motors, which are configured to transmit different (e.g., asymmetrical) motion to the mouthpiece.

In some embodiments, the mouthpiece has a customized size and/or shape, and includes customized cleaning tips. For example, the length, shape, stiffness, and material of the cleaning tips is customized to the particular user's dentition (e.g., jaw, mouth, and teeth geometry).

In some embodiments, the dental care device is configured to operate at a customizable range of vibration frequencies, and/or with a customizable range of displacement (e.g., of one or more portions of the dental care device) to ensure proper cleaning using multiple motors to create different kinds of motion, which, when put together in a sequence, ensures proper whole-mouth cleaning. In some embodiments, the vibration frequencies include one or more frequencies in the sonic range and/or one or more frequencies in the ultrasonic range.

In some embodiments, the dental care device is configured to gather personalized data to guide a personalized treatment plan. In some embodiments, the personalized treatment plan includes a plurality of different frequencies selected based on the user's dental information. In some embodiments, the dental care device is configured to send feedback to the user's dental health provider (e.g., to confirm that the user is complying with a prescribed treatment regime, or for use in future diagnoses, prescriptions, and/or procedures). In some embodiments, the information about the user's dentition along with usage and feedback information from the dental care device is automatically mined via AI (Artificial Intelligence) and ML (Machine Learning) to identify and/or predict dental issues and/or problem areas.

Thus, devices and systems are provided with methods for customizing and improving dental health, thereby increasing the effectiveness, efficiency, and user comfort while such devices and systems are used.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1C shows an exemplary mouthpiece of a customized toothbrush device, in accordance with some embodiments.

FIGS. 2A-2B shows an exemplary drive assembly configured to be coupled to a mouthpiece, in accordance with some embodiments.

FIGS. 3A-3B shows an exemplary toothbrush device, including a mouthpiece and a drive assembly, in accordance with some embodiments.

FIGS. 4A-4B show exemplary movement of a drive assembly while motors of the drive assembly are in operation, in accordance with some embodiments.

FIGS. 5A-5B show exemplary movement a customized toothbrush device while the customized toothbrush device is in operation, in accordance with some embodiments.

FIG. 6 shows exemplary movement a customized toothbrush device, including cleaning trays and cleaning elements, while the customized toothbrush device is in operation, in accordance with some embodiments.

FIGS. 7A-7B show exemplary regions for grouping teeth, and determining a linear fit based on teeth within at least one region of teeth.

FIGS. 8A-8B show exemplary movement of a curved region of a mouthpiece, where the exterior and interior walls of the curved region change in shape in a similar fashion.

FIGS. 9A-9B show exemplary movement of a curved region of a mouthpiece, where the exterior and interior walls of the curved region change in shape in an opposite fashion.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Reference will now be made in detail to embodiments, examples of which are illustrated in the accompanying drawings. In the following detailed descriptions, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

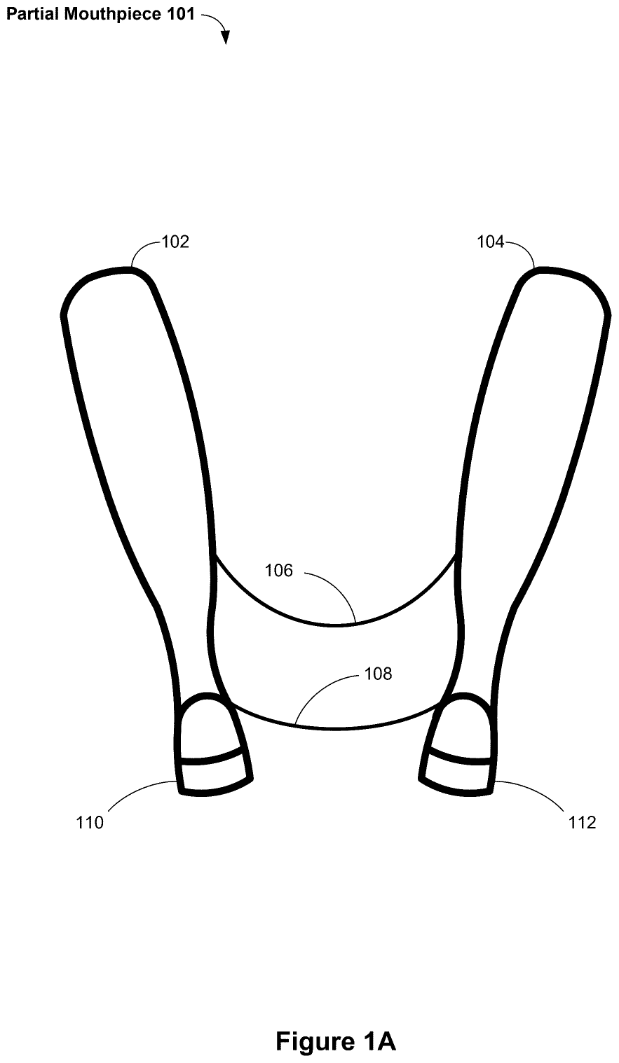

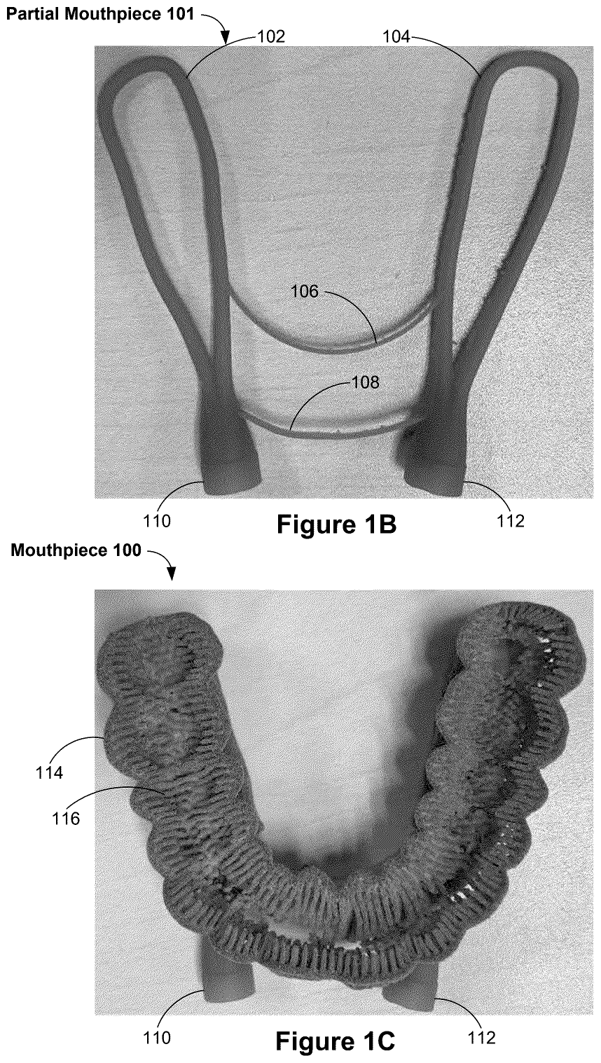

FIG. 1A shows a schematic view of a support structure of a partial mouthpiece 101 (e.g., a portion of a mouthpiece 100, as described below, with other portions of the mouthpiece 100 removed for illustration purposes) of a customized toothbrush device. In the descriptions below, “mouthpiece 100” is sometimes used interchangeably with “partial mouthpiece 101.” For example, FIG. 1A shows the partial mouthpiece 101 for illustration purposes, but some descriptions of FIG. 1A refer to the mouthpiece 100 (e.g., as the mouthpiece 100 is what a user would place in the user's mouth, not a partial mouthpiece 101). The support structure of the partial mouthpiece 101 in FIG. 1A includes a right portion 102 (e.g., that corresponds to a portion of the partial mouthpiece 101 that is configured to receive the right portion of a user's teeth and gums when the mouthpiece 100 is in use), a left portion 104 (e.g., that corresponds to a portion of the partial mouthpiece 101 that is configured to receive the left portion of the user's teeth and gums when the mouthpiece 100 is in use).

In some embodiments the right portion 102 and/or the left portion 104 are have a wire-like or tube-like structure, such that the right portion 102 and/or the left portion 104 form open loop(s). This minimizes the amount of material needed to form the support structure of the partial mouthpiece 101/mouthpiece 100, which helps minimize the weight of the mouthpiece 100, and the cost to manufacture the mouthpiece 100.

In some embodiments, the right portion 102 includes a connection point 110, and the left portion 104 includes a connection point 112. The connection point 110 and the connection point 112 are configured to attached to a drive assembly. In some embodiments, the connection point 110 and the connection point 112 are configured to connect to or receive a separate (e.g., and detachable) attachment mechanism (e.g., a magnet/magnetic material, a hook, a latch, or any other suitable attachment mechanism) for coupling with a corresponding attachment mechanism on a drive assembly (e.g., that has two corresponding attachment points configured to couple with the connection point 110 and the connection point 112), which allows the mouthpiece 100 to be manufactured (e.g., 3-D printed) from a single material with the attachment mechanisms to be inserted afterwards (e.g., after 3-D printing).

In some embodiments, a shape of the right portion 102 and/or the left portion 104 is based at least in part on the teeth and/or gums of a user (e.g., a particular user for which the mouthpiece 100 is specifically customized). For example, the user's mouth (e.g., including the user's teeth and gums) is 3-D scanned, and the 3-D scan is used to customize the size and/or shape of the support structure of the mouthpiece 100 (e.g., and/or the partial mouthpiece 101 shown in FIG. 1A).

In some embodiments, the right portion 102 and the left portion 104 are connected via a connector 106 and a connector 108. The connector 106 and/or the connector 108 are formed from a flexible material such that the right portion 102 and the left portion 104 can be moved independently (e.g., with the connector 106 and the connector 108 flexing or bending in order to accommodate the different movement of the right portion 102 and the left portion 104). In some embodiments, the connector 106 and/or the connector 108 are integrally formed with the left portion 102 and the right portion 104, and are optionally integrally formed from the same material. In some embodiments, the connector 106 and/or the connector 108 are thinner (or smaller in size in at least one dimension, e.g., diameter) as compared to the wire-like/tube-like structure of the right portion 102 and/or the left portion 104, to improve the flexibility of the connector 106 and/or the connector 108.

FIG. 1B shows an example partial mouthpiece 101 (e.g., support structure of the mouthpiece 100) (e.g., after 3-D printing the support structure as a single, integral unit). FIGS. 1A and 1B illustrates the partial mouthpiece 101 with a particular configuration, but one skilled in the art would understand that any suitable configuration can be used (e.g., with any suitable shape of the right region 102 and the left region 104, with any suitable number of connectors and or connecting features between the right region 102 and the left region 104, and/or any number and/or locations of suitable connection points for the connector 106, the connector 108, and/or any additional connectors.

FIG. 1C shows an example mouthpiece 100, including a customized cleaning tray 600 and cleaning elements which are customized for a user of the mouthpiece 100. In some embodiments, a cleaning tray 114 includes customized cleaning elements 116. In some embodiments, the cleaning tray 114 and/or the cleaning elements 116 are customized based on the teeth and/or gums of a particular user. For example, a size and/or shape of the cleaning tray 114 is customized to fit a mouth of a particular user. For example, a size, length, angle, distribution, density, and/or shape of the cleaning elements 116 are customized such that the (e.g., all) of the cleaning elements are configured to contact a particular's teeth and gums (e.g., with a consistent contact force across cleaning elements, to provide adequate cleaning of the user's teeth and/or gums when the mouthpiece 100 is in use).

In some embodiments, customizations for the cleaning tray 114 and/or the cleaning elements 116 include customizing the positioning and/or properties of the cleaning elements based on identified areas of concern or weaknesses in the corresponding dental arch of the user. Areas of the particular user's teeth that are identified as actual or potential problem areas (e.g., suffering decay or early indicators of decay, or identified as particularly difficult to clean areas) may be have an increased bristle stiffness or concentration on the corresponding areas of the cleaning cavity 127. A method of facilitating personal dental cleaning consistent with the disclosure can in such cases include performing a dental scan of the user, identifying actual or potential problem areas based on the dental scan, and customizing the spatial arrangement and/or distribution of different types of cleaning elements (or cleaning elements with different physical properties) in the cleaning cavity 127 based on the identified problem areas.

In some embodiments, customizations for the cleaning tray 114 include customizing a length of the cleaning tray 114 (e.g., based on the length of a dental arch of a particular user's mouth), customizing a width of the cleaning tray 114 (e.g., based on the width of the dental arch of the particular user's mouth), customizing a distance between an outer boundary wall and an inner boundary wall the cleaning tray 114, customizing a density of one or more surfaces of the cleaning tray 114, and/or customizing an internal structure of the cleaning tray 114 (e.g., to use a mesh or lattice structure for a respective surface, rather than a solid surface).

In some embodiments, customizations for the cleaning elements 116 include customizing a length of one or more cleaning elements of the cleaning elements 116 to ensure the cleaning elements reach the surface of the particular user's teeth (e.g., and/or to include an “interference distance” by which the length of the cleaning elements extend beyond the surface of the particular user's teeth), customizing a spacing between cleaning elements of the cleaning elements 116, customizing a diameter of one or more cleaning elements of the cleaning elements 116, customizing a taper of one or more cleaning element of the cleaning elements 116, customizing an angle of one or more cleaning element of the cleaning elements 116 (e.g., relative to a surface of cleaning tray 114), customizing a density of one or more cleaning element of the cleaning elements 116, customizing a surface texture (or pattern) of one or more cleaning elements of the cleaning elements 116, customizing a cross-section of one or more cleaning element of the cleaning elements 116, customizing the spatial distribution of the cleaning elements 116, and/or customizing a material composition of one or more cleaning elements of the cleaning elements 116.

In some embodiments, each cleaning element of the cleaning elements 116 is individually customized based on the particular user's mouth (e.g., the shape, size, position, and spacing of tooth surfaces of the teeth of the particular user's mouth; an interproximal distance between the particular user's teeth; one or more missing teeth in the particular user's mouth; a gum condition of the particular user's mouth; an enamel condition of one or more teeth of the particular user's mouth; the presence of dental correctors in the particular user's mouth; the presence of one or more third molars in the particular user's mouth, the presence of dental hardware such as inlays, onlays, crowns, veneers, bridges, implants, etc., in the particular user's mouth; a width of the particular user's teeth; and a gum health state of the particular user's mouth). In some embodiments, each cleaning element of the cleaning elements 116 is individually customized by selecting a value for a physical characteristic of the cleaning element. In some embodiments, this individual customization includes selecting a respective value for a physical characteristic for each respective cleaning element of the cleaning elements 116, such that a respective cleaning element of the cleaning elements 116 contacts a respective tooth of the particular user's mouth with a predetermined amount of contact force (e.g., 0-12 Newtons). In some embodiments, the predetermined amount of contact force is selected based on efficacy (e.g., to ensure the set of cleaning elements can clean the user's teeth effectively), comfort (e.g., similar to soft and firm toothbrushes), and/or the particular user's needs and requirements. In some embodiments, this individual customization includes selecting a respective value for a physical characteristic for each respective cleaning element of the cleaning elements 116, such that a respective cleaning element of the cleaning elements 116 contacts a respective tooth of the particular user's mouth with a predetermined amount of overlap with a surface of the particular user's mouth. In some embodiments, the predetermined amount of contact force and/or the predetermined amount of overlap are achieved by customizing an amount of interference distance. In some embodiments, each cleaning element has the same interference distance. In some embodiments, the interference distances are customized per cleaning element, or subset of cleaning elements (e.g., cleaning elements corresponding to sensitive regions of the particular user's mouth may have smaller interference distances than cleaning elements corresponding to other regions of the particular user's mouth).

Additional customizations relating to the cleaning tray 114 and/or the cleaning elements 116 are described in U.S. Provisional Application No. 63/443,357 and U.S. Pat. No. 11,213,118, both of which are incorporated by reference in their entirety.

In some embodiments, the cleaning tray 114 and the cleaning elements 116 are integrally formed (e.g., 3-D printed) with the support structure (e.g., the right portion 102, the left portion 104, the first connector 10, and the second connector 108) such that the mouthpiece 100 is formed as a single, integral unit. In some embodiments, the cleaning tray 114 and the cleaning elements 116 are integrally formed (e.g., 3-D printed) as a single, integral unit, but are not integrally formed with the support structure. In some embodiments, the cleaning tray 114 (along with the cleaning elements 116) are 3-D printed over the support structure. In some embodiments, the cleaning tray 114 (including the cleaning elements 116) are fastened or secured to the support plate (e.g., after separately 3-D printing the cleaning tray 114, and the support structure). In some embodiments, since the cleaning tray 114 and the cleaning elements 116 will need to be replaced over time (e.g., the cleaning elements 116 will wear down over time due to repeated contact with the user's teeth during use of the mouthpiece 100), separately manufacturing the cleaning tray 114 and the cleaning elements 116 minimizes the amount of material needed to manufacture replacement parts for the mouthpiece 100 (e.g., which also reduces the cost to manufacture and/or maintain the mouthpiece 100).

In some embodiments, the cleaning elements are configured to contact the teeth of a user without contacting the gums of the user (e.g., to prevent gum discomfort, and/or to allow gums to heal). In some embodiments, the cleaning elements are configured to contact both the teeth of the user and the gums of the user (e.g., to improve gum health), and optionally, cleaning elements configured to contact the gums of the user are configured differently than cleaning elements configured to contact the teeth of the user (e.g., the cleaning elements configured to contact the gums of the user are softer, thicker, and/or rounder to minimize discomfort and reduce the risk of damaging the user's gums). In some embodiments, the cleaning elements are configured to clean (e.g., and optionally, contact) the interface of the teeth and gums (e.g., the regions of the user's mouth where the teeth and gums meet).

While not visible in FIG. 1C, in some embodiments, the mouthpiece 100 includes at least one additional cleaning tray that is analogous to the cleaning tray 114 (e.g., with cleaning elements analogous to the cleaning elements 116). For example, FIG. 1C depicts a “top” cleaning tray 114, which is configured to receive a user's upper teeth and gums (e.g., and optionally, the cleaning elements 116 are customized based on the user's upper teeth and gums). The mouthpiece 100 also includes a “bottom” cleaning tray, which is configured to receive the user's lower teeth and gums (e.g., and optionally, the cleaning elements of the bottom cleaning tray are customized based on the user's lower teeth and gums). In some embodiments, the mouthpiece 100 is customized based on a 3-D dental scan of a user's teeth. In some embodiments, the mouthpiece 100 is partially customized based on a partial 3-D dental scan of a user's teeth (e.g., a 3-D dental scan of some, but not all, of a user's teeth).

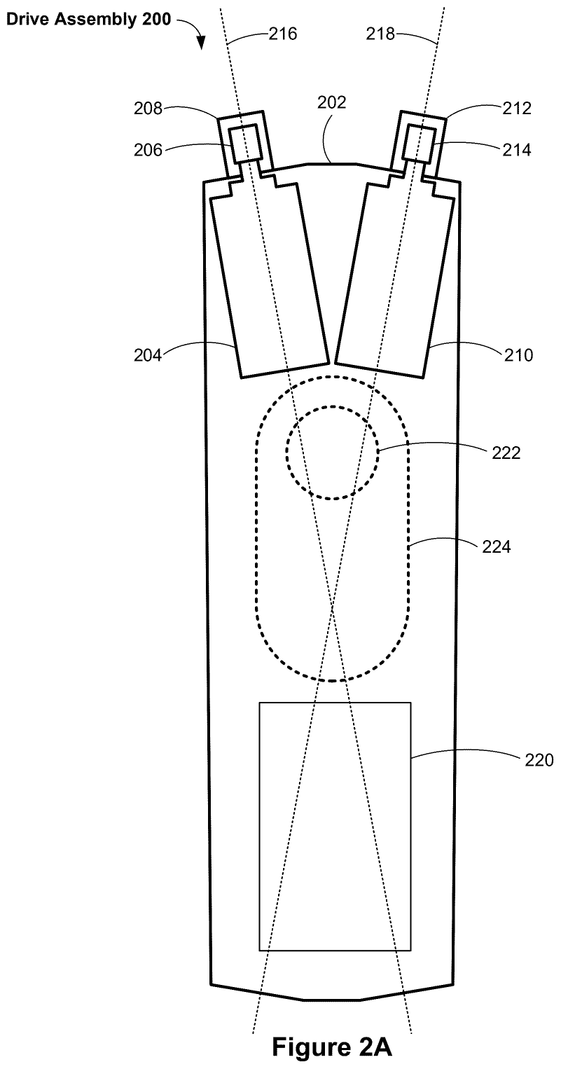

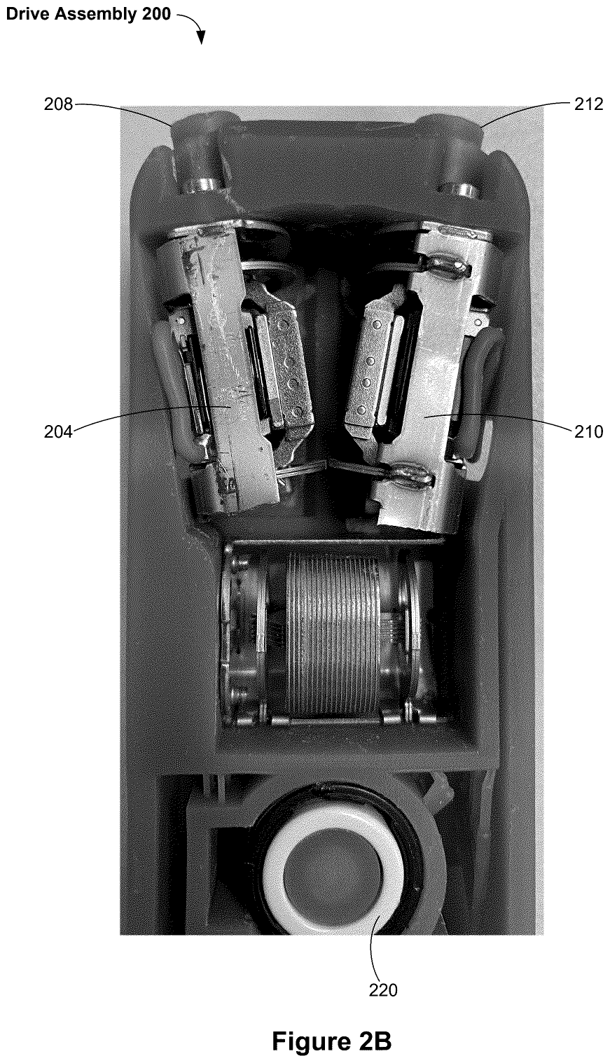

FIG. 2A shows a schematic view of a drive assembly 200, which is configured to couple with the mouthpiece 100. The drive assembly 200 includes a connection point 206 inside a housing 208, and the connection point 206 is configured to couple with the connection point 110 of the mouthpiece 100. The connection point 206 is connected to a motor 204, which is configured to drive (e.g., move) the connection point 206 (e.g., back and forth) along an axis 216 within the housing 208. The drive assembly 200 also includes a connection point 214 inside a housing 212, and the connection point 214 is configured to couple with the connection point 112 of the mouthpiece 100. The connection point 214 is connected to a motor 210, which is configured to drive (e.g., move) the connection point 214 (e.g., back and forth) along an axis 218 within the housing 212.

The motor 204 and the motor 210 are contained within a housing 202, which also includes a battery 220. In some embodiments, the drive assembly 200 includes a display 224 (e.g., for displaying instructions and/or status information regarding the customized toothbrush device) and a button 222 (e.g., for operating the drive assembly 200). In some embodiments, the display 224 and the button 222 are included on an outer surface of the house 202, and are shown with dotted lines in FIG. 2A (e.g., because the surface of the housing 202 that includes the display 224 and the button 222 would not be visible in the schematic view of the drive assembly 200).

In some embodiments, the motor 204 and the motor 210 are angled at a 17.5 degree offset (e.g., the angle between the axis 216 and a vertical axis is 17.5 degrees, the angle between the axis 218 and the vertical axis is 17.5 degrees, and the angle between the axis 216 and the axis 218 is 35 degrees). In some embodiments, the motor 204 and the motor 210 are angled at another suitable degree of offset (e.g. 5 degrees, 10 degrees, 15 degrees, 20 degrees, or 25 degrees from the vertical axis, corresponding to a 10 degree, 20 degree, 30 degree, 40 degree, or 50 degree angle between the motor 204/axis 216 and the motor 210/axis 218). In some embodiments, the motor 204 and the motor 210 are angled between 10-25 degrees. In some embodiments, the motor 204 and the motor 210 are angled between 10-20 degrees. In some embodiments, the angle of the motor 204 and/or the motor 210 are adjustable (e.g., can be adjusted to an offset angle between 0-25 degrees, or 0-20 degrees; or can be adjusted to an offset angle between 10-20 degrees, or 10-25 degrees). In some embodiments, the motor 204 and the motor 210 are angled at least in part based on the teeth (e.g., dental arch) of a user.

In some embodiments, the motor 204 and/or the motor 210 are connected to a portion of the housing 202 by an adjustable connection point (e.g., a pivot point) that allows the offset angle of the motor 204 and/or the motor 210 to be adjusted. In some embodiments, the motor 204 and/or the motor 210 are connected to each other by an adjustable connection (e.g., that allows the angle of the motor 204 relative to the motor 210 to be adjusted, and/or allows the offset angle of both the motor 204 and the motor 210 to be simultaneously adjusted).

In some embodiments, the motor 204 and the motor 210 are managed by the same motor controller, and the motor 214 and the motor 210 are driven at the same speed, but in opposite directions. In some embodiments, the motor 204 and the motor 210 are the same type of motor (e.g., identical motors), but the motor 204 is connected to the power source with a first polarity, while the motor 210 is connected to the power source with a polarity opposite the first polarity (e.g., such that the components of the motor 210 and the motor 204 move in opposite directions).

In some embodiments, the drive assembly 200 includes one or more counterweights (not shown) that are configured to offset the motion of the motor 204 and the motor 210. In some embodiments, the counterweight(s) are configured to offset the combined motion of the motor 204 and the motor 210 (e.g., as the motor 204 may already partially offset movement of the motor 210, if the motor 204 and the motor 210 are configured to operate 180 degrees out of phase). This helps minimize the amount of movement (e.g., vibration) that is transferred to a user of the mouthpiece 100 while coupled to the drive assembly 200 (e.g., to reduce vibrations in the user's entire head, and/or in locations beyond just the user's mouth). In some embodiments, the drive assembly 200 includes one or more damping elements (e.g., padding or cushioning, springs, and/or shock-absorbent material) between the motor 204 and the motor 210, and the housing 202.

In some embodiments, the drive assembly 200 includes memory for storing different vibrational frequencies, amplitudes, and/or patterns (e.g., drive profiles). In some embodiments, a vibrational frequency, amplitude, and/or pattern changes during a cleaning cycle in accordance with a preset drive profile. In some embodiments, one or more drive profiles are user configurable (e.g., for user comfort and/or based on user preference). In some embodiments, one or more drive profiles are configured by a dental profession (e.g., a dentist) in order to ensure proper cleaning of the user's teeth and/or gums. In some embodiments, the motor 204 and/or the motor 210 are configured to generate vibrational frequencies in the sonic and/or ultrasonic range. Additional details regarding drive profiles is described in U.S. Pat. No. 10,869,541, which is incorporated by reference in its entirety.

In some embodiments, the drive assembly 200 (e.g., the motor 204 and/or the motor 210 of the drive assembly 200) are configured to generate specific vibrational frequencies, amplitudes, and/or patterns (e.g., optionally, in accordance with a preset drive profile), wherein the specific vibrational frequencies, amplitudes, and/or patterns are selected in order to cause the mouthpiece 100 to exhibit specific “vibrational modes” (e.g., patterns of motion). For example, the motor 204 and/or the motor 210 are configured to operate a specific vibrational frequency that causes the two ends of the U-shape of the mouthpiece 100 to move together in an alternating upward and downward motion (e.g., back and forth in a vertical direction). Other examples of vibrational modes include vibrational modes where the two ends of the U-shape move opposite one another (e.g., one end moves downward when the other end moves upward, and vice versa); vibrational modes where the two ends of the U-shape move together (or opposite one another) in a left and right motion (e.g., back and forth in a horizontal direction); and/or vibrational modes where the two ends of the U-shape rotate (e.g., about a z-axis that runs from the end of the U-shape to the bottom/bowl of the U-shape) in a clockwise (or counterclockwise) direction (e.g., either with both ends of the U-shape rotating in the same direction, or with different ends of the U-shape rotating in opposite directions). Additional details regarding vibrational modes is described in U.S. application Ser. No. 17/865,363, which is incorporated by reference in its entirety.

In some embodiments, the drive assembly 200 includes communications circuitry for communicating with external devices. For example, the drive assembly 200 can transmit information to (and/or receive information from) a smartphone device (e.g., to allow a user to control the drive assembly 200 and/or adjust one or more settings for the drive assembly 200, via the smartphone device). For example, the drive assembly 200 can receive information from a personal computer (and/or another electronic device with internet access) to provide firmware updates, and/or one or more drive profiles (e.g., received remotely and/or over the internet, from a dental professional).

In some embodiments, the mouthpiece 100 includes one or more sensors (not shown) configured to collect usage data and/or biometric data relating to the user's teeth and gums. In some embodiments, the drive assembly 200 stores the collected data, and can provide summary information to a user's smartphone (e.g., regarding the user's brushing habits) and/or a dental professional (e.g., to assist with development of personalized dental treatment plans, and/or to better track the user's dental health and/or identify dental problems). In some embodiments, the collected data can be mined and/or analyzed by artificial intelligence (AI) and/or machine learning (ML) algorithms to identify and/or predict dental issues and/or problem areas of the user's teeth and/or gums (e.g., plaque buildup, cavities, and/or gum recession).

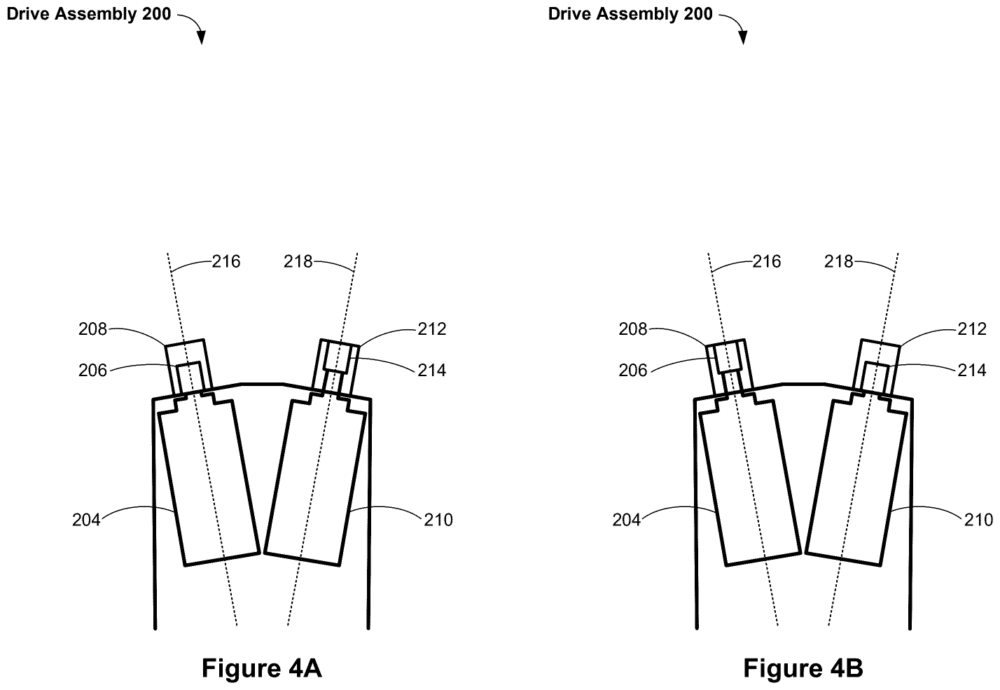

FIG. 2B shows an exemplary drive assembly 200 (e.g., with portions of the housing 202 removed, in order to reveal the motor 204 and the motor 210. For ease of illustration and description, FIGS. 2A and 2B show the drive assembly 200 with 2 motors (e.g., the motor 204 and the motor 210). In some embodiments, the drive assembly 200 includes a different number of motors (e.g., 1 motor, 3 motors, 4 motors, etc.). In some embodiments, each motor is connected to a respective connection point (e.g., 3 motors and 3 connection points, with each motor connected to a different connection point). In some embodiments, the number of motors and the number of connection points are different (e.g., 1 motor connected to two connection points), and various mechanisms (e.g., motor shafts, gears, arms, or any other suitable component) connect the motor(s) to the connection points (e.g., to achieve analogous motion to the motion described below with respect to FIGS. 4A-6).

In some embodiments, the drive assembly 200 includes one or more sensors (not shown) configured to determine a bite force of a user (e.g., applied to the mouthpiece 100) while the drive assembly 200 is connected to the mouthpiece 100. Determining the bite force of the user can help assist with mouthpiece design (e.g., for future and/or replacement mouthpieces, to increase comfort and/or efficacy, based on how hard a user generally bites down on a mouthpiece), and/or to help determine optimal drive frequencies and/or drive patterns to achieve optimal motion of cleaning elements in the mouthpiece 100.

Including the one or more sensors in the drive assembly 200 allows the bite force applied by a user to be determined without needing to include sensors in the mouthpiece 100 itself. As the mouthpiece 100 will need to be replaced more often than the drive assembly 200, this reduces the cost and complexity of fabricating the mouthpiece 100. This also reduces the risk of damage to relevant sensors, as sensors included in the mouthpiece 100 are more at risk of exposure to moisture (e.g., from water, saliva, toothpaste, and/or cleaning fluids). A non-exhaustive list of exemplary sensors is provided below.

In some embodiments, the drive assembly 200 includes one or more accelerometers for determining a change in motion of the drive assembly (e.g., between a default motion of the drive assembly 200, such as when the drive assembly 200 is not connected to the mouthpiece 100 and/or when the user is not biting down on the mouthpiece 100, and when the drive assembly is connected to the mouthpiece 100 while the user is biting down on the mouthpiece 100). In some embodiments, the drive assembly 200 includes one or more current sensors, for determining a power increase or decrease based on motor load (for one or more of the motors of the drive assembly 200). In some embodiments, the drive assembly 200 includes one or more microphones, for determining a change in motor pitch as the load on one or more motors of the drive assembly 200 changes. In some embodiments, the drive assembly 200 includes one or more physical mechanisms that have a defined amount of deflection and/or movement under a known load (e.g., and changes to the amount of deflection and/or movement can be used to determine the load on one or more motors of the drive assembly 200).

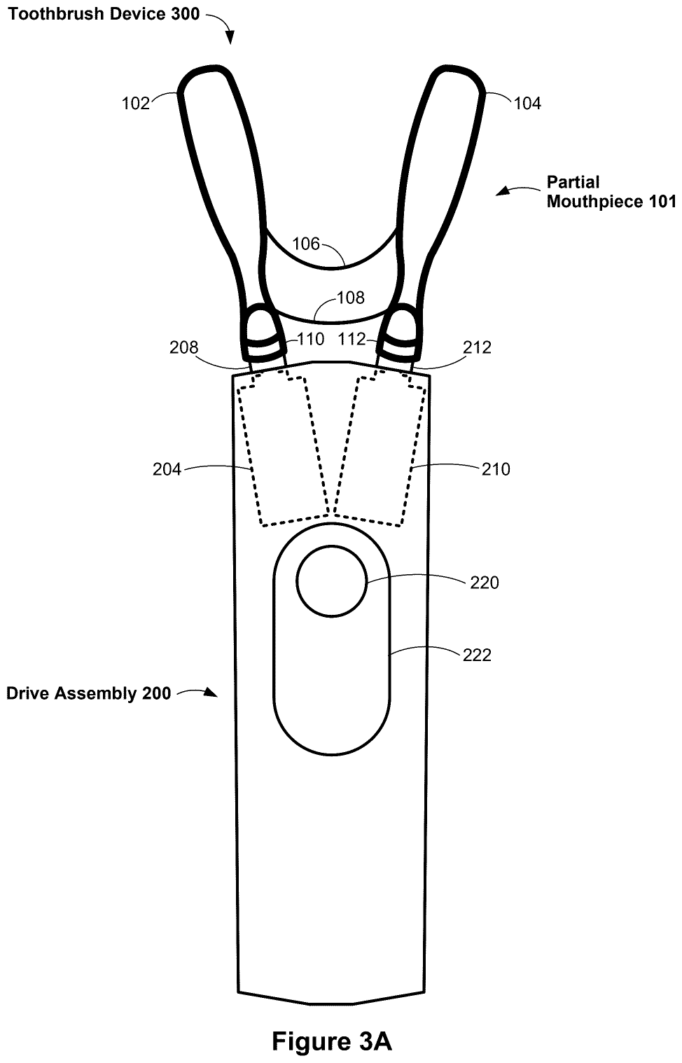

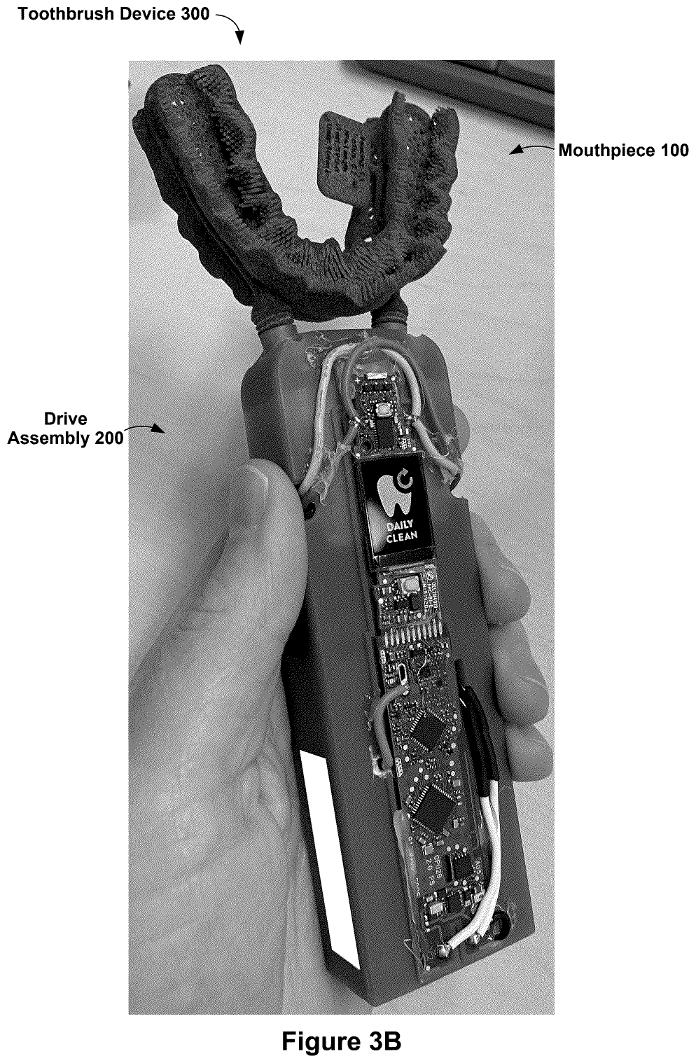

FIG. 3A shows a customized toothbrush device 300, which includes the mouthpiece 100 and the drive assembly 200. For illustration purposes, the mouthpiece 100 is represented by the partial mouthpiece 101 (e.g., of FIG. 1) and the internal components of the drive assembly 200 are also illustrated. The mouthpiece 100 couples with the drive assembly at two distinct connection points (e.g., as shown by the location of the connection point 110 and the connection point 112 of the mouthpiece 100).

FIG. 3B shows the customized toothbrush device 300, which includes the mouthpiece 100 (e.g., including the cleaning tray 114 and the cleaning elements 116) and the drive assembly 20-0 (e.g., with portions the housing 202 of the drive assembly 200 removed, for illustration purposes, to show the internal components of the drive assembly 200).

In some embodiments, the mouthpiece 100 is not customized (e.g., based on a default design and/or configuration) and/or is only partially customized (e.g., portions of the mouthpiece 100 are customized, but other portions of the mouthpiece 100 use a default design and/or configuration). In some embodiments, the un-customized or partially customized mouthpiece 100 can be fabricated in a plurality of different sizes (e.g., 10-40 different sizes). This allows a user to try the customized toothbrush device 300 without needing to obtain (e.g., and pay for) a 3-D dental scan and/or fabrication/3-D printing of a customized mouthpiece, and also allows a user to trial different sizes of mouthpiece to find a comfortable size (e.g., without needing to fabricate/3-D print a fully customized mouthpiece in different sizes). In turn, this reduces the cost to the user (e.g., can try the customized toothbrush device 300 without needing to pay the entire upfront cost for full customization), streamlines the customization process (e.g., the user can determine a correct size for the mouthpiece before any customizations are made to the mouthpiece), and reduces waste product (e.g., minimizes the number of mouthpieces needed to achieve an optimal and/or comfortable fit for the user).

FIGS. 4A-4B show the movement of the connection point 206 and the connection point 214 when the drive assembly 200 is in operation. In FIG. 4A, the motor 204 moves the connection point 208 closer to the motor 204, along the axis 216. At the same time, the motor 210 moves the connection point 214 away from the motor 210, along the axis 218. In other words, there is a simultaneous push (e.g., by the motor 210) and pull (e.g., by the motor 204), and the motor 210 and the motor 204 alternate between pushing and pulling (e.g., after the motor 210 pushes and the motor 204 pulls, the motor 210 then pulls and the motor 204 then pushes).

In FIG. 4B, the motor 204 moves the connection point 208 away from the motor 204, along the axis 216, while the motor 210 moves the connection point 214 closer to the motor 210, along the axis 218. From the state shown in FIG. 4B, the motor 204 then moves the connection point 206 back towards to motor 204, and the motor 210 moves the connection point 214 away from the motor 210 (e.g., the motor 204 and the motor 210 continue to move their respective connection points back to the locations shown in FIG. 4A). The motor 204 and the motor 210 continue to move the connection point 206 and the connection point 214, respectively, in a back and forth motion (e.g., the connection points alternate between the location shown in FIG. 4A and FIG. 4B).

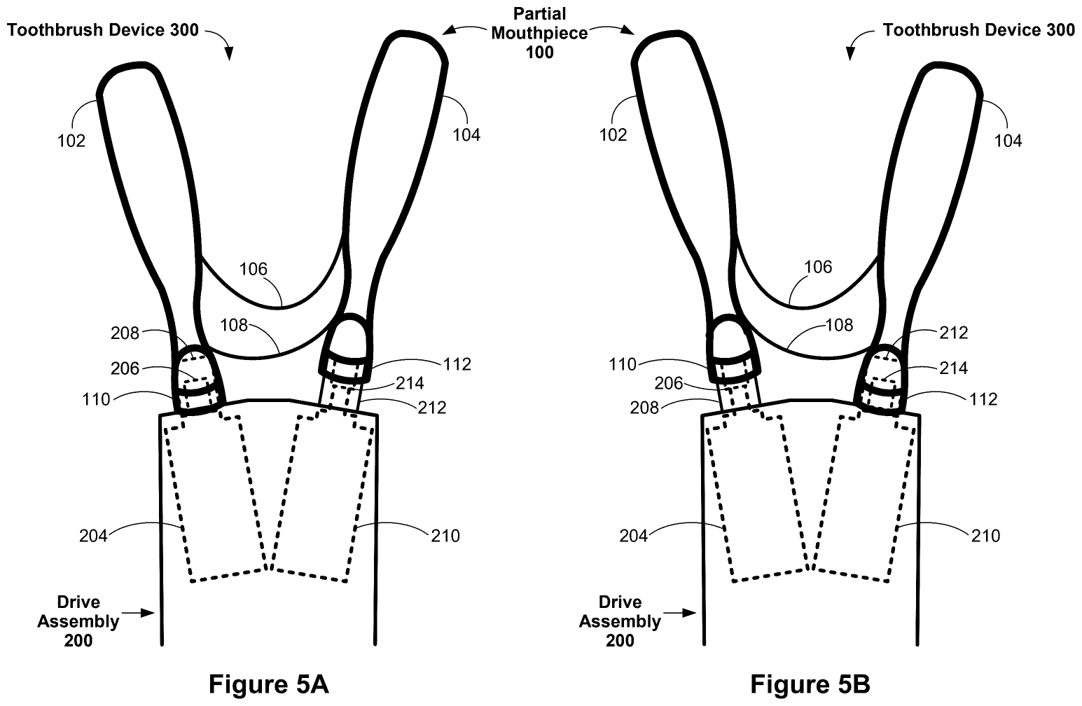

FIGS. 5A-5B show the movement of the connection point 110 and the connection point 112 (e.g., along with the connection point 206 and the connection point 212 of the drive assembly 200) when the mouthpiece 100 (represented by the partial mouthpiece 101, for illustration purposes) is coupled to the drive assembly 200 (e.g., to complete the customized toothbrush device 300), while the customized toothbrush device 300 is in operation. In FIGS. 5A-5B, the motor 204 and the motor 210, the connection point 206 and the connection point 214, and the housing 208 and the housing 212, are shown with a dotted outlines for reference. These features would not normally be visible due to being covered by portions of the mouthpiece 100, and/or due to being internal components of the drive assembly 200 (e.g., except for portions of the housing 212 in FIG. 5A, and portions of the housing 208 in FIG. 5B).

The motor 204 and the motor 210 move the connection point 206 and the connection point 214 in the same manner as described above with reference to FIGS. 4A-4B. When the connection point 110 and the connection point 112 are coupled to the connection point 206 and the connection point 214, the motor 2014 and the motor 210 also cause the mouthpiece 100 to move.

In FIG. 5A, the motor 204 moves the connection point 206 towards the motor 204, which also causes the connection point 110 of the mouthpiece 100 (e.g., and thus the right portion 102 of the mouthpiece 100) to move closer to the drive assembly 200. The motor 210 moves the connection point 214 away from the motor 210, which also causes the connection point 112 (e.g., and thus the left portion 104 of the mouthpiece 100) to move away from the drive assembly 200. The connector 106 and the connector 108 flex (e.g., bend) as the right portion 102 of the mouthpiece 100, and the left portion 104 of the mouthpiece 100, move (e.g., independently of one another).

In FIG. 5B, the motor 204 moves the connection point 206 away the motor 204, which also causes the connection point 110 of the mouthpiece 100 (e.g., and thus the right portion 102 of the mouthpiece 100) to move away to the drive assembly 200. The motor 210 moves the connection point 214 towards from the motor 210, which also causes the connection point 112 (e.g., and thus the left portion 104 of the mouthpiece 100) to move towards the drive assembly 200. The connector 106 and the connector 108 flex (e.g., in an opposite manner, as compared to FIG. 5A) as the right portion 102 of the mouthpiece 100, and the left portion 104 of the mouthpiece 100, move (e.g., independently of one another).

The alternating movement of the right portion 102 of the mouthpiece 100, and the left portion 104 o the mouthpiece 100, each being driven by a different motor (e.g., the motor 204 and the motor 210, respectively), moves the cleaning elements 116 of the mouthpiece 100 in an analogous manner to a traditional brushing motion of a non-electric toothbrush. This alternating movement transfers energy (e.g., vibrational movement) more efficiently to the mouthpiece 100, which provides more effective cleaning of a user's teeth.

In some embodiments, the mouthpiece 100 includes (e.g., two) flexible sleeves that contain the connection point 110 and the connection point 112, and the flexible sleeves are configured to remain substantially stationary while other portions of the mouthpiece 100 move. While the support structure of the mouthpiece 100 moves as shown in FIGS. 5A and 5B, the flexible sleeves remain in contact with housing 208 and the housing 212 (e.g., and/or the housing 202 of the drive assembly 200). This allows the mouthpiece 100 to be driven by the motor 204 and the motor 210, while protecting the moving elements of the customized toothbrush device 300 (e.g., the connection point 206 within the housing 208, and the connection point 214 within the housing 212) from exposure to toothpaste, saliva, and/or water, which can negatively impact the freedom of movement of these portions of the customized toothbrush device 300.

FIGS. 5A-5B show only the support structure (e.g., of FIG. 1A) of the mouthpiece 100, to better illustrate the movement of the mouthpiece 100. The movement shown in FIGS. 5A-5B is exaggerated for illustration purposes. In some embodiments, the motor 204 and the motor 210 are configured to move the connection point 206 and the connection point 214 on a millimeter scale, such that the distance between the two extremes of the movement of the connection points is 0.1 mm, 0.2 mm, 0.5 mm, 0.75 mm, or 1 mm (e.g., the connection points are moved/displaced by +/−0.05 mm, 0.1 mm, 0.25 mm, 0.375 mm from a central and/or default position). In some embodiments, the motor 204 and the motor 210 are configured to move the connection point 206 and the connection point 214 by an amount that is based at least in part on the size and/or distance between cleaning elements of the cleaning elements 116. For example, if the cleaning elements 116 have an average spacing of 1-1.1 mm, the motor 204 and the motor 210 are configured to move the connection point 206 and the connection point 214 by 0.75 mm, which transmits a sufficient amount of movement to the cleaning elements 216 (e.g., based on the spacing of the cleaning elements 216) to clean a user's teeth, without causing user discomfort with large amounts of movement of the mouthpiece 100.

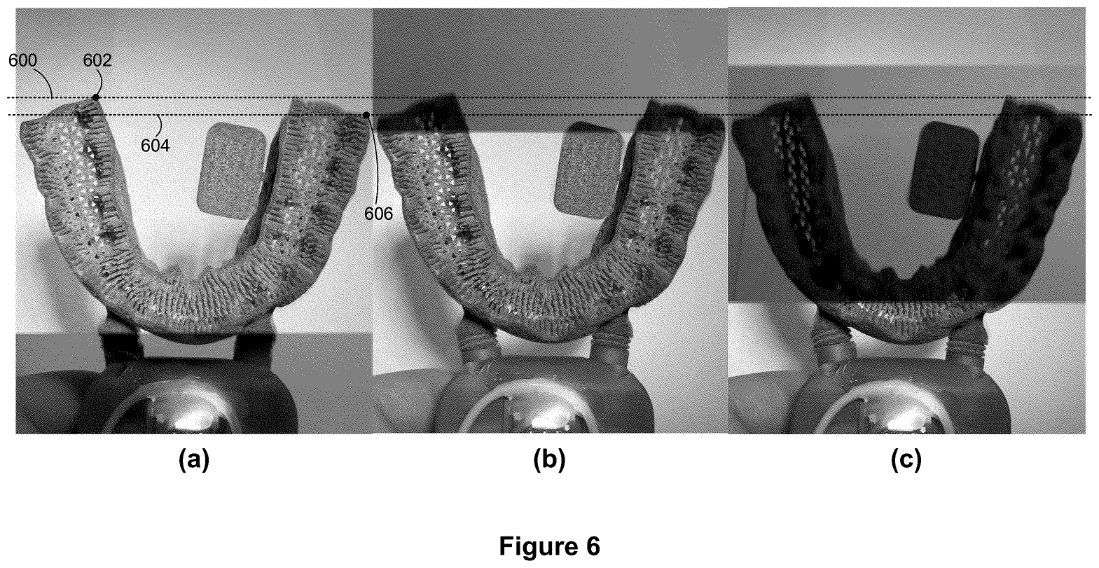

FIG. 6 shows the movement of the mouthpiece 100, including the dental tray 114 and the cleaning elements 116 shown in FIG. 1C. A reference line 600 marks the position of a corner 602 (e.g., an inner back corner of the right portion) of the mouthpiece 100, in FIG. 6(a). A reference line 604 marks the position of a corner 606 (e.g., an outer back corner of the left portion) of the mouthpiece 100, in FIG. 6(a). In FIG. 6(b), the corner 602 moves above the reference line 600, while the corner 606 moves below the reference line 604. In FIG. 6(c), the corner 602 returns to a location close to the reference line 600 (e.g., the position of the corner 602 in FIG. 6(a) is substantially the same as the position of the corner 602 in FIG. 6(c)), and the corner 606 returns to a location close to the reference line 604 (e.g., the position of the corner 604 in FIG. 6(a) is substantially the same as the position of the corner 604 in FIG. 6(c)).

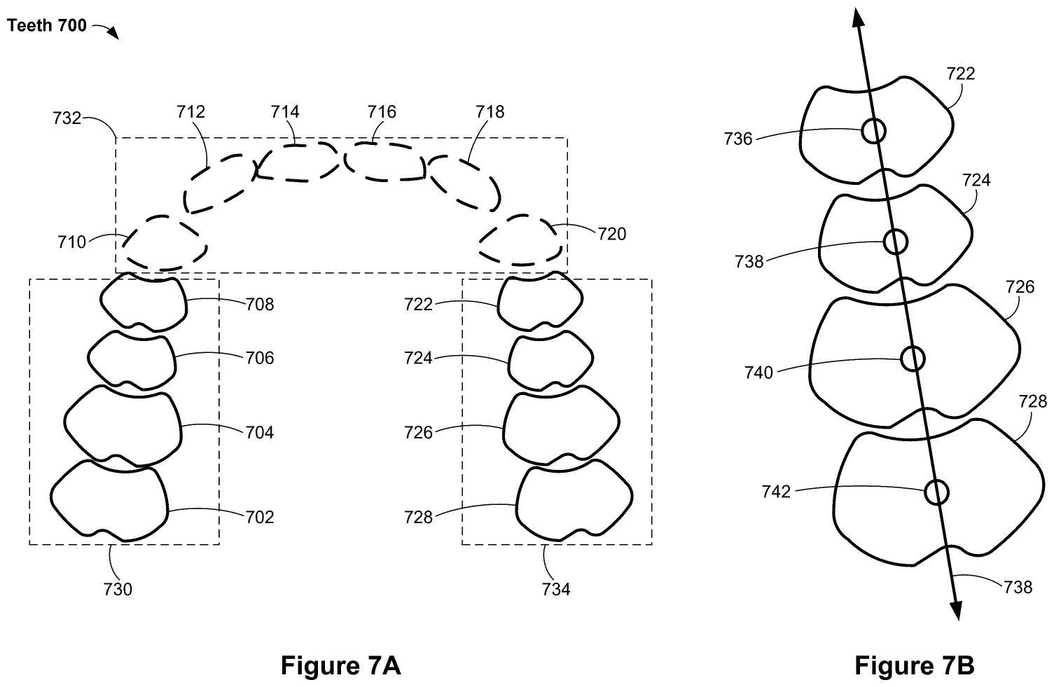

FIGS. 7A-7B illustrate an exemplary set of teeth 700 for a particular user, and how, in accordance with some embodiments, the set of teeth 700 can be used to assist in designing and customizing a mouthpiece for the particular user.

In FIG. 7A, the set of teeth 700 is divided into three distinct regions. A first region 730 includes a left molar 702, a left molar 704, a left molar 706, and a left molar 706, of the set of teeth 700 (henceforth “left molars of the teeth 700”). A second region 732 includes non-molar teeth, including a tooth 710, a tooth 712, a tooth 714, a tooth 716, a tooth 718, and a tooth 720, of the set of teeth 700 (henceforth “front teeth of the teeth 700”). A third region 734 includes a right molar 722, a right molar 724, a right molar 726, and a right molar 728, of the set of teeth 700 (henceforth “right molars of the teeth 700”).

In some embodiments, a customized mouthpiece (e.g., the mouthpiece 100 described above with reference to FIG. 1A, and/or the mouthpiece 600 described above with reference to FIG. 6) is divided into three region, corresponding to the region 730, the region 732, and the region 743. In some embodiments, these three regions are conceptual (e.g., for purposes of grouping and organizing the teeth of the user), and are not reflected in the actual manufacture or fabrication of a customized mouthpiece (e.g., the mouthpiece 100 is manufactured/fabricated as a single, integral mouthpiece, and not in three distinct sections corresponding to the region 730, the region 732, and the region 734).

The portions of the mouthpiece corresponding to the region 730 and the region 734 are configured to move in a predominately linear fashion (e.g., as there is minimal curvature reflected in the positions of the left molars and the right molars of the teeth 700). The direction of this linear motion can be customized based on a particular user's teeth, as described in further detail below. The portion of the mouthpiece corresponding to the region 732 is configured to move with a curved (e.g., circular and/or elliptical) motion, to account for the curvature of the front teeth of the teeth 700.

FIG. 7B shows a magnified view of the right molars of the teeth 700. FIG. 7B also shows an exemplary approximation of a linear fit for the right molars of the teeth 700 (in and/or corresponding to the region 734). As shown in FIG. 7B, a linear fit can be calculated based on a centroid for each molar of the right molars of the teeth 700 (e.g., by a computer, based on a 3-D dental scan of the user's molars, or another electronic representation of the teeth 700). For example, the molar 722 has a centroid 736, the molar 724 has a centroid 738, the molar 726 has a centroid 740, and the molar 728 has a centroid 742. A linear fit 738 (e.g., a linear regression or a line of best fit) is determined, based on the centroids 736, 738, 740, and 742. In some embodiments, the linear fit 738 may be adjusted (e.g., manually, by a dental professional or by a particular user), to achieve a better fit and/or for increased comfort while the mouthpiece is in use. A corresponding linear fit is calculated for the left molars of the teeth 700, using an analogous process to the one described above for the right molars of the teeth 700.

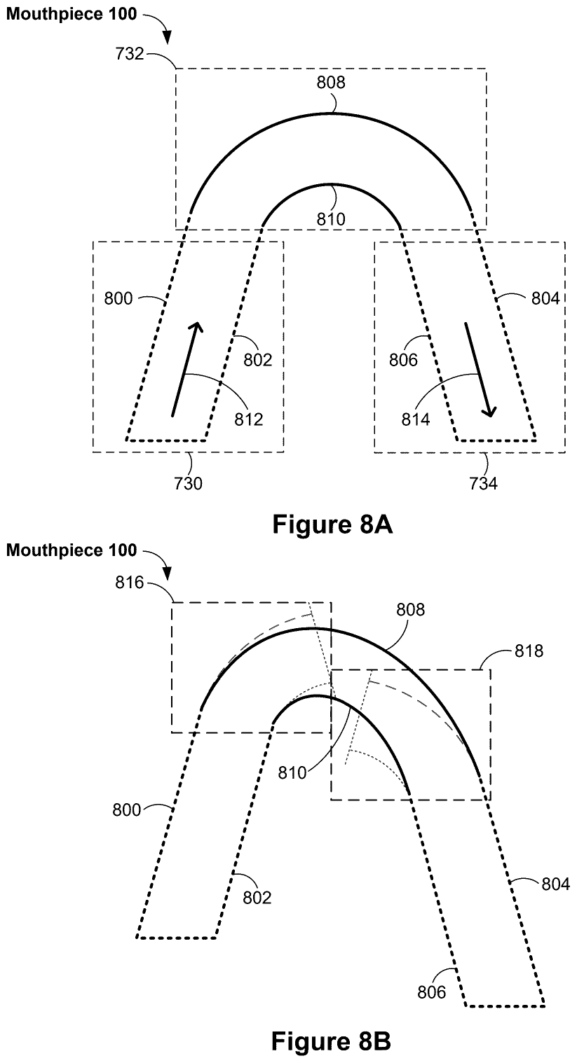

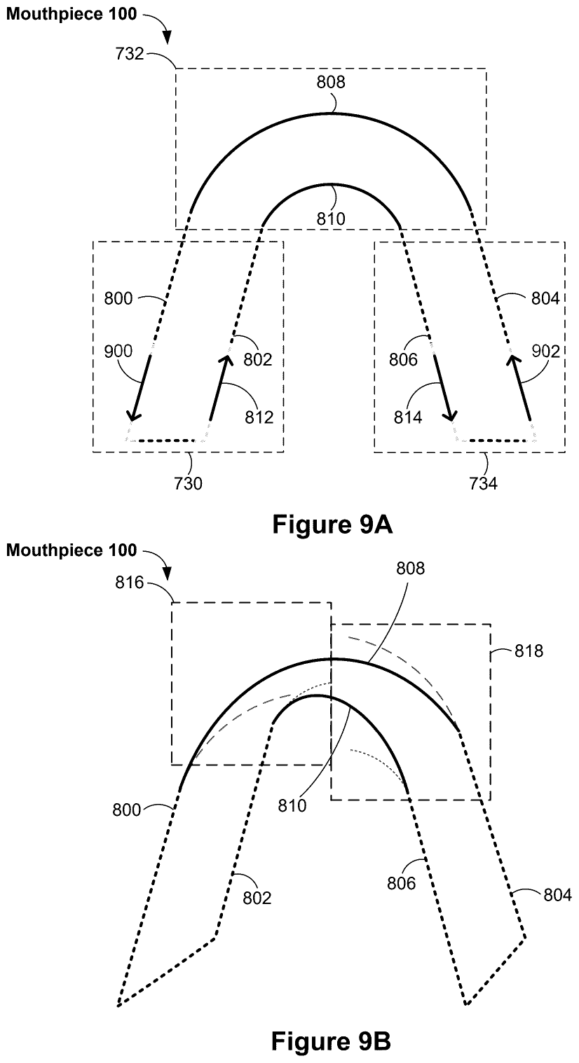

In some embodiments, as discussed in greater detail below with reference to FIGS. 8A-9B, the linear fit 738 is used (e.g., at least in part) to determine an angle of one or more portions of a customized mouthpiece (e.g., angles for the right portion 102 and/or the left portion 104 of the mouthpiece 100 in FIGS. 1A and 5A-5B) and/or an angle for a motor of a drive assembly (e.g., the motor 204 of the drive assembly 200 in FIGS. 2A and 5A-5B is configured to drive the right portion 102 along a direction parallel to the linear fit 738; and the motor 210 of the drive assembly 200 is configured to drive the left portion 102 along a direction parallel to a linear fit calculated for the left molars of the teeth 700). In some embodiments, the motor(s) of the drive assembly are configured to drive portions of the mouthpiece in directions that are substantially (e.g., but not precisely) parallel to the linear fit 738 and/or the linear fit calculated for the left molars of the teeth 700 (e.g., the applied force vector corresponding to the motor(s) of the drive assembly are substantially parallel to the linear fit(s)). In some embodiments, suitable motion of the mouthpiece 100 can be achieved if the applied force vector corresponding to the motor(s) is within +/−30 degrees of the corresponding linear fit. In some embodiments, the applied force vector corresponding to the motor(s) is less than +/−5 degrees from the corresponding linear fit.

FIGS. 8A-8B show a simplified view of the mouthpiece 100, while the mouthpiece 100 is in motion (e.g., drive by the drive assembly 200). For clarity of illustration, FIG. 8A shows an outline (e.g., exterior and interior walls) of the mouthpiece 100, but does not include other details of the mouthpiece 100 (e.g., other features that are shown in FIG. 1A). For ease of discussion, the term “arc” is used to describe the state of one or more walls of the mouthpiece 100, but it is understood that in some embodiments, the actual state of the one or more walls is not precisely an arc (e.g., and instead has a more complicated and/or irregular curvature, but can be approximated by an arc).

In FIG. 8A, the simplified mouthpiece is shown in three parts. The region 730, 732, and 734 are overlaid on the mouthpiece 100 to provide a reference for which teeth of the teeth 700 (in FIGS. 7A-7B) would be located in which portions of the mouthpiece 100. These regions can also be used to describe three different regions of the mouthpiece.

The mouthpiece 100 includes two (e.g., substantially) linear regions, which correspond to the region 730 and the region 734. A left linear region corresponding to the region 730 includes a wall 808 (e.g., a portion of an exterior or facial wall of the mouthpiece 100) and a wall 802 (e.g., a portion of an interior or lingual wall of the mouthpiece 100). A right linear region corresponding to the region 734 includes a wall 804 (e.g., a portion of an exterior or facial wall of the mouthpiece 100) and a wall 806 (e.g., a portion of an interior or lingual wall of the mouthpiece 100).

The mouthpiece 100 also includes a curved region, corresponding to the region 732, which includes a curved wall 808 (e.g., a portion of an exterior or facial wall of the mouthpiece 100) and a curved wall 810 (e.g., a portion of an interior or lingual wall of the mouthpiece 100). In FIG. 8A, the shape of the curved wall 808 and the curved wall 810 is symmetrical about a vertical axis.

FIG. 8B shows a view of the simplified mouthpiece while the mouthpiece is in motion (e.g., being driven by the drive assembly 200). The state shown in FIG. 8B is analogous to the state shown (in with greater details) in FIG. 5B, but FIG. 8B provides a clearer illustration of the change in state for the wall 808 and the wall 810 in the curved portion of the mouthpiece (corresponding to the region 732 in FIG. 8A).

As shown in FIG. 8B, the left linear section of the mouthpiece moves “up” (e.g., along the direction 812) while the right linear section of the mouthpiece moves down” (e.g., along the direction 814). The wall 808 and the wall 810 change shape (e.g., bend and/or deform) to accommodate the movement of the left linear section and the right linear section. The wall 808 and the wall 810 no longer exhibit the vertical symmetry in FIG. 8A.

Instead, the shape of a portion of the wall 808 and a portion of the wall 810, in a left region 816, changes (e.g., in the left region 816, the arcs of the wall 808 and the wall 810 increase such that the wall 808 and the wall 810 appear more curved relative to the wall 800 and the wall 802, respectively; and/or a radii of the wall 808 and the wall 810 decrease in FIG. 8B as compared to FIG. 8A). For comparison, the dashed arc in the left region 816 shows (a portion of) the original shape of the wall 808 (e.g., as in FIG. 8A), and the dotted line shows (a portion of) the original shape of the wall 810 (e.g., as in FIG. 8A).

The shape of a portion of the wall 808 and a portion of the wall 810, in a right region 818, also changes (e.g., in the right region 818, the arcs of the wall 808 and the wall 810 increase such that the wall 808 and the wall 810 appear less curved relative to the wall 800 and the wall 802, respectively; and/or a radii of the wall 808 and the wall 810 decrease in FIG. 8B as compared to FIG. 8A; and/or a radii of the wall 808 and the wall 810 are increased in FIG. 8B as compared to FIG. 8A). For comparison, the dashed arc in the left region 816 shows (a portion of) the original shape of the wall 808 (e.g., as in FIG. 8A), and the dotted line shows (a portion of) the original shape of the wall 810 (e.g., as in FIG. 8A).

Changing the shape of the wall 808 and the wall 810 allows different cleaning elements located along the wall 808 and the wall 810 to be moved at different speeds. For example, cleaning elements along the wall 810 in the region 818 will move faster than cleaning element along the wall 810 in the region 802 (e.g., faster movement is required to traverse the larger radius of the arc of the wall 810 in the region 818). Additionally, cleaning elements along the wall 810 will move differently to cleaning elements along the wall 808 (e.g., because the radius of the wall 808 is different from the radius of the wall 810, requiring different amounts of movement).

While the description of FIG. 8B describes a particular state of the mouthpiece 100 while in use (e.g., the left linear section moved closer to the front of the mouthpiece that includes the wall 808 and the wall 810, and the right linear section moved further from the front of the mouthpiece that includes the wall 808 and the wall 810), when connected to the drive assembly 200 (e.g., and while being driven by the drive assembly 200), the mouthpiece 100 (e.g., the left linear portion and the right linear portion of the mouthpiece 100) is configured to move back in forth in an alternating pattern (e.g., the left linear portion alternates between moving in the direction 812 and a direction opposite the direction 812, and the right linear portion alternates between moving in the direction 814 and a direction opposite the direction 814). FIG. 8B describes the state of the mouthpiece 100 at one particular extreme of the range of motion, and at an opposite extreme of the range of motion, the descriptions of FIG. 8B are reversed with respect to right and left. Additional details regarding the alternating motion are described above with reference to FIGS. 5A-5B.

In FIGS. 8A-8B, the wall 800 and the wall 802 are configured to move in substantially the same direction (e.g., along the direction 812), and the wall 806 and the wall 804 are configured to move in substantially the same direction (e.g., along the direction 814). In some embodiments, the left linear section includes attachment or bridging elements that connect the wall 800 and the wall 802, and the right linear section includes attachment or bridging elements and the wall 804 and the wall 806. In contrast, no attachment or bridging elements connect the wall 808 and the wall 810, allowing the wall 808 and the wall 810 to move independently of one another, and providing structural flexibility for the left linear section and the right linear section of the mouthpiece 100 to move along the direction 812 and the direction 814 (e.g., without substantially altering a shape of the left linear section and/or the right linear section of the mouthpiece 100).

In some embodiments, (e.g., at least) two motors (e.g., of the drive assembly 200) are configured to transfer energy to move the wall 802, the wall 802, the wall 804, and the wall 806 as described above with reference to FIGS. 8A-8B. For example, one motor drives movement of the wall 800 and the wall 802 in the direction 812, and a second motor drives movement of the wall 804 and the wall 806 in the direction 814. In some embodiments, the two motors are configured to be driven 180 degrees out of phase (e.g., with alternating and/or opposite movement relative to each other). In some embodiments, the two motors are configured to be driven 30-180 degrees out of phase (e.g., the two motors are staggered, and do not necessarily move with an alternative and/or opposite movement relative to each other).

In some embodiments, more than two motors of the drive assembly 200 are connected to the mouthpiece (e.g., a first motor drives movement of the wall 800 in the direction 812, a second motor drives movement of the wall 802 in the direction 812, a third motor drives movement of the wall 806 in the direction 814, and a fourth motor drives movement of the wall 804 in the direction 814). In some embodiments, any suitable number of motors and/or connection points can be used to achieve the motion of the wall 800, the wall 802, the wall 804, and the wall 806 described above.

FIGS. 9A-9B are analogous to FIGS. 8A-8B, but illustrates alternating movement of walls of the mouthpiece 100. As shown in FIG. 9A, in some embodiments, the wall 800 and the wall 802 in the region 730 are configured to move in opposite directions (e.g., the wall 800 moves in a direction 900 while the wall 802 moves in the direction 812), and the wall 804 and the wall 806 in the region 734 are configured to move in opposite directions (e.g., the wall 804 moves in the direction 814 while the wall 804 moves in a direction 902).

As shown in FIG. 9B, the wall 808 and the wall 810 change in shape to accommodate the movement of the wall 800, the wall 802, the wall 804, and the wall 806. In contrast to FIG. 8B, where the portion of the wall 808 and the portion of the wall 810 in the region 816 change in shape in a similar fashion (e.g., in the region 816, the arcs of the wall 808 and the wall 810 both increase; and/or the radii of the wall 808 and the wall 810 are both decreased), in FIG. 9B, the portion of the wall 808 and the portion of the wall 810 in the region 816 change shape in an opposite fashion (e.g., in the region 816, the arc of the wall 808 decreases while the arc of the wall 810 increases; and/or the radius of the wall 808 increases while the radius of the wall 810 decreases).

The portion of the wall 808 and the portion of the wall 810 in the region 818 similarly change in shape in an opposite fashion (e.g., in the region 818, the arc of the wall 808 increases while the arc of the wall 810 decreases; and/or the radius of the wall 808 decreases while the radius of the wall 810 increases).

While the description of FIG. 9B describes a particular state of the mouthpiece 100 while in use. FIG. 9B describes the state of the mouthpiece 100 at one particular extreme of the range of motion, and at an opposite extreme of the range of motion, the descriptions of FIG. 9B are reversed with respect to right and left. Additional details regarding the alternating motion are described above with reference to FIGS. 5A-5B.

In some embodiments, four motors of the drive assembly 200 are connected to the mouthpiece (e.g., a first motor drives movement of the wall 800 in the direction 900, a second motor drives movement of the wall 802 in the direction 812, a third motor drives movement of the wall 806 in the direction 814, and a fourth motor drives movement of the wall 804 in the direction 902). In some embodiments, any suitable number of motors and/or connection points can be used to achieve the motion of the wall 800, the wall 802, the wall 804, and the wall 806 described above (e.g., more than four motors of the drive assembly 200 are connected to the mouthpiece, at four or more connection points on the mouthpiece 100).

In some embodiments, the four motors are divided into two pairs, and the two pairs are configured to be driven 180 degrees out of phase (e.g., one pair of motors moves in a first direction while the second pair of motors moves in a direction opposite the first direction). In some embodiments, the two pairs are configured to be driven 30-180 degrees out of phase (e.g., the motion of the two pairs of motors is staggered).

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A personalized toothbrush device, comprising:
a drive mechanism, comprising:
a first motor connection point;
a second motor connection point; and
one or more motors;
a customized mouthpiece configured to couple with the drive mechanism, the customized mouthpiece comprising:
a first region including a first mouthpiece connection point that is configured to couple to the first motor connection point;
a second region including a second mouthpiece connection point that is configured to couple to the second motor connection point; and
a third region connecting the first region and the second region, such that the first region can be moved independently of the second region.

2. The personalized toothbrush device of claim 1, wherein:
the drive mechanism further comprises:
a first motor connected to the first motor connection point; and
a second motor connected to the second motor connection point; and
the first motor drives the first region of the customized mouthpiece in a first direction, while the second motor drives the second region of the customized mouthpiece is a second direction that is different from the first direction.

3. The personalized toothbrush device of claim 2, wherein the first motor and the second motor are configured to operate out of phase, such that a vector component of the first direction is generally opposite a vector component of the second direction.

4. The personalized toothbrush device of claim 2, wherein the first direction and the second direction are offset by an angle that is less than or equal to 40 degrees.

5. The personalized toothbrush device of claim 2, wherein the first direction and the second direction are offset by an angle that is between 5 and 20 degrees.

6. The personalized toothbrush device of claim 2, wherein the first direction and the second direction are offset by an angle that is between 10 and 20 degrees.

7. The personalized toothbrush device of claim 2, wherein the first direction and the second direction are offset by an angle that is between 15 and 25 degrees.

8. The personalized toothbrush device of claim 2, wherein the first direction and the second direction are offset by an angle that is between 15 and 20 degrees.

9. The personalized toothbrush device of claim 1, wherein the customized mouthpiece comprises:
one or more customized dental trays configured to receive a user's teeth and gums; and
a plurality of cleaning elements, customized based at least in part on the user's teeth and gums.

10. The personalized toothbrush device of claim 9, wherein each cleaning element of the plurality of cleaning elements is customized at least in part on the user's teeth and gums.

11. The personalized toothbrush device of claim 1, wherein the customized mouthpiece is formed as a single, integrated unit.

12. The personalized toothbrush device of claim 1, wherein the customized mouthpiece is 3-D printed.

13. The personalized toothbrush device of claim 1, wherein the first region and the second region are configured to move by at most 3 mm, in respective linear directions generally along respective lines connecting centroids of teeth in respective regions of the first region and the second region, when the personalized toothbrush device is in operation.

14. The personalized toothbrush device of claim 1, wherein:
the third region includes a first wall and a second wall; and
the first wall and the second wall are configured to change in curvature when the first region and the second region of the customized mouthpiece are moved.

15. The personalized toothbrush device of claim 14, wherein the first wall changes in curvature in a first manner and the second wall changes in curvature in a second manner that is different from the first manner.

16. The personalized toothbrush device of claim 14, wherein:
a left portion of the first wall and a left portion of the second wall change in curvature in a first manner; and
a right portion of the first wall and a right portion of the second wall change in curvature in a second manner that is different from the first manner.

17. The personalized toothbrush device of claim 14, wherein:
a left portion of the first wall and a right portion of the second wall change in curvature in a first manner; and
a right portion of the first wall and a left portion of the second wall change in curvature in a second manner that is different from the first manner.
